(19) United States
(12) Patent Application Publication
(10) Pub. No.: US 2013/0097453 A1
(43) Pub. Date: Apr. 18, 2013

(54) APPARATUS AND METHOD FOR CONTROLLING CPU IN PORTABLE TERMINAL

(71) Applicant: Samsung Electronics Co., Ltd., Gyeonggi-do (KR)

(72) Inventors: Chi-Jeong CHOI, Gyeonggi-do (KR); Tae-Youn KWON, Gyeonggi-do (KR)

(73) Assignee: Samsung Electronics Co., Ltd., Gyeonggi-do (KR)

(21) Appl. No.: 13/651,620

(22) Filed: Oct. 15, 2012

(30) Foreign Application Priority Data
Oct. 14, 2011 (KR) 10-2011-0105287

(51) Int. Cl. G06F 1/08

(52) U.S. Cl. 713/501

(57) ABSTRACT

The present disclosure relates to an apparatus and a method for controlling a central processing unit in a portable terminal The method includes: operating a first core among multiple cores included in the central processing unit within a range of pre-designated limited clock frequencies; identifying the number of work queues corresponding to the number of processings being delayed by the central processing unit; comparing the identified number of work queues with a pre-designated reference value; and operating the first core and a second core among the multiple cores at a maximum clock frequency when a result of the comparison shows that the identified number of work queues exceeds the reference value.

### CLAIM OF PRIORITY

This application claims priority under 35 U.S.C. §119(a) to a Korean Patent Application entitled “Apparatus and Method for Controlling CPU in Portable Terminal” filed in the Korean Intellectual Property Office on Oct. 14, 2011 and assigned Serial No. 10-2011-0105287, the contents of which are incorporated herein by reference.

### BACKGROUND OF THE INVENTION

1. Field of the Invention

The present invention relates to a portable terminal, and more particularly to an apparatus and a method for controlling a Central Processing Unit (CPU) in a portable terminal.

2. Description of the Related Art

Portable terminals, such as a smart phone, a tablet PC, etc., provide many useful functions to a user with many different applications. Therefore, by providing various functions, a portable terminal enables the use of various types of information together with a voice communication function.

As the functions provided by the portable terminal become more diversified, the growing number of operations causes an increase in power consumption, causing a frequent replacement of a battery.

Particularly, when the amount of load to be handled by a core is equal to or greater than a predetermined value, the core included in a Central Processing Unit (CPU) operates at a maximum clock frequency. For example, when a governor which controls a clock frequency of the CPU sets a policy for controlling a CPU clock to an on-demand mode, the core operates at the maximum clock frequency despite the small amount of load to be handled by the core.

However, an increase in power consumption is caused by operation of the core at the maximum clock frequency regardless of the core load. Therefore, the above operation of the core is a main factor for the frequent replacement of a battery in the portable terminal.

Therefore, there has been an increasing need for a method for controlling the CPU so as to enable optimization of power consumption of the CPU included in the portable terminal.

### SUMMARY OF THE INVENTION

Accordingly, an aspect of the present invention is to solve the above-mentioned problems, and to provide an apparatus and a method for controlling a CPU so as to enable optimization of power consumption of the CPU.

In accordance with an aspect of the present invention, an apparatus for controlling a central processing unit in a portable terminal includes: a controller for operating a first core among multiple cores included in the central processing unit within a range of pre-designated limited clock frequencies, identifying the number of work queues corresponding to the number of processings being delayed by the central processing unit, comparing the identified number of work queues with a pre-designated reference value, and operating the first core and a second core among the multiple cores at a maximum clock frequency when a result of the comparison shows that the identified number of work queues exceeds the reference value.

In accordance with another aspect of the present invention, a method for controlling a central processing unit in a portable terminal includes: operating a first core among multiple cores included in the central processing unit within a range of pre-designated limited clock frequencies; identifying the number of work queues corresponding to the number of processings being delayed by the central processing unit; comparing the identified number of work queues with a pre-designated reference value; and operating the first core and a second core among the multiple cores at a maximum clock frequency when a result of the comparison shows that the identified number of work queues exceeds the reference value.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a block diagram illustrating the configuration of a portable terminal according to an exemplary embodiment of the present invention;

FIG. 2 is a block diagram illustrating the configuration of a CPU controller according to a first embodiment of the present invention;

FIG. 3 is a flowchart illustrating a method for controlling a CPU by a CPU controller according to a first embodiment of the present invention;

FIG. 4 a block diagram illustrating the configuration of a CPU controller according to a second embodiment of the present invention; and

FIG. 5 is a flowchart illustrating a method for controlling a CPU by a CPU controller according to a second embodiment of the present invention.

### DETAILED DESCRIPTION

Hereinafter, exemplary embodiments of the present invention will be described in detail with reference to the accompanying drawings. For the purposes of clarity and simplicity, a detailed description of publicly-known functions and configurations which may unnecessarily obscure the subject matter of the present invention will be omitted.

Portable terminal according to an exemplary embodiment of the present invention, which are electronic devices portable so as to be easily carried, may include a video phone, a mobile phone, a smart phone, an IMT-2000 (International Mobile Telecommunication 2000) terminal, a WCDMA (Wideband Code Division Multiple Access) terminal, a UMTS (Universal Mobile Telecommunication Service) terminal, a PDA (Personal Digital Assistant), a PMP (Portable Multimedia Player), a DMB (Digital Multimedia Broadcasting) terminal, an e-book, portable computers (e.g. a laptop, a tablet PC, etc.), a digital camera, etc.

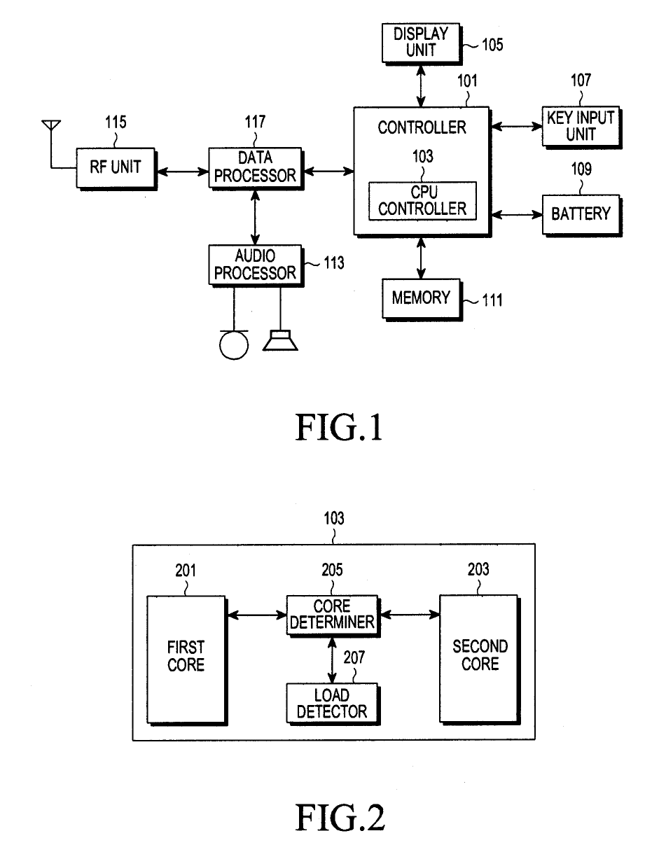

FIG. 1 is a block diagram illustrating the configuration of a portable terminal according to an exemplary embodiment of the present invention.

Referring to FIG. 1, a portable terminal includes a controller(or processor) 101, a display unit 105, a key input unit 107, a battery 109, a memory 111, an audio processor 113, an RF unit 115, and a data processor 117.

In operation, the RF unit 115 performs a wireless communication function of the portable terminal. More specifically, the RF unit 115 includes an RF transmitter for upconverting the frequency of a signal to be transmitted and then amplifying the frequency-upconverted signal, an RF receiver for low-noise amplifying a received signal and then downconverting the frequency of the low-noise amplified signal, etc. Also, the data processor 117 includes a transmitter for encoding and modulating a signal to be transmitted, a receiver for demodulating and decoding a signal received by the RF unit 123, etc. The data processor 117 may include a modem (modulator/demodulator) and a codec (coder/decoder), and the codec may include a data codec for processing packet data and the like, and an audio codec for processing audio signals including voice and the like.

The audio processor 113 reproduces a received audio signal that has been output from the data processor 117, through a speaker or transmits an audio signal to be transmitted, which is generated from a microphone, to the data processor 117. The key input unit 107 may include keys for inputting numbers and text information, and function keys for setting various functions. The display unit 105 displays an image signal on a screen thereof, and displays data that the controller 101 has been requested to output.

When the display unit 105 employs a capacitive/electrostatic touch screen, a resistive/pressure sensitive touch screen or the like, the key input unit 107 may include only a minimum number of keys which have previously been set, and the display unit 105 may include keys other than a minimum number of keys of the key input unit 107.

Therefore, the display unit 105 may perform a function of inputting other keys, in addition to a key input function of the key input unit 107.

The battery 109 includes a main battery and an auxiliary battery. The main battery may be removed/attached from/to the portable terminal, has a larger capacity than that of the auxiliary battery, and supplies power to the elements of the portable terminal. Also, the auxiliary battery has a capacity equal to or smaller than about 1 milliampere-hours (mAh). When power of the portable terminal is turned off, the auxiliary battery supplies minimum power, which may update time information of the controller 101, to the controller 101, and is charged by power supplied from the main battery.

The memory 111 includes a program memory and a data memory. In the present example, the program memory stores a booting and Operating System (OS) for controlling a general operation of the portable terminal, and the data memory stores various pieces of data generated during operation of the portable terminal.

The controller 101 controls an overall operation of the portable terminal Particularly, a CPU (Central Processing Unit) controller 103 included in the controller 101 controls multiple cores included in a CPU.

More specifically, in a CPU with dual cores, when power of the portable terminal has been turned on, the CPU controller 103 operates one core within a range of pre-designated limited clock frequencies.

In the embodiment, a limited clock frequency is a clock frequency which is set within a range between a maximum clock frequency and a minimum clock frequency of a core, and is set as a clock frequency or a higher one at which most applications or programs may be smoothly processed. Such a limited clock frequency is determined in consideration of a correlation between a core and between load which the core may handle for a pre-designated time period.

For example, when the maximum clock frequency of the core is equal to 1.5 GHz, a limited clock frequency may be set to 1.2 GHz. As another example, when the maximum clock frequency of the core is equal to 1.2 GHz, a limited clock frequency may be set to 1 GHz.

Then, the CPU controller 103 identifies the number of work queues that the CPU must currently process. In the embodiment, multiple requests that the CPU must process are registered to a work queue, and the number of work queues may be represented on a thread-by-thread basis. As described above, the CPU controller 103 may detect the number of requests that the CPU must process, by identifying the number of work queues.

Next, the CPU controller 103 compares the identified number of work queues with a first reference value. Herein, the first reference value is pre-designated, and represents the number of work queues that one core operating within a range of limited clock frequencies is capable of processing while a user of the portable terminal cannot recognize a processing delay.

When a result of the comparison shows that the identified number of work queues exceeds the first reference value, the CPU controller 103 controls dual cores so as to operate at the maximum clock frequency, and so as to quickly handle a delayed load. Otherwise, when the identified number of work queues is equal to or less than the first reference value, the CPU controller 103 controls one core so as to operate within the range of limited clock frequencies, and so as to handle the delayed load.

Further, in a CPU with quad cores, when power of the portable terminal has been turned on, the CPU controller 103 operates one core within a range of pre-designated limited clock frequencies.

Then, the CPU controller 103 identifies the number of work queues that the CPU must currently process. In the present example, because multiple requests that the CPU must process are registered to a work queue, the CPU controller 103 may detect the number of requests that the CPU must process, by identifying the number of work queues.

Next, the CPU controller 103 compares the identified number of work queues with a first reference value. Herein, the first reference value is pre-designated, and represents the number of work queues that one core operating within a range of limited clock frequencies is capable of processing while a user of the portable terminal cannot recognize a processing delay.

When a result of the comparison shows that the identified number of work queues exceeds the first reference value, the CPU controller 103 controls dual cores so as to operate at a limited clock frequency, and so as to quickly handle a delayed processing request. Otherwise, when the identified number of work queues is equal to or less than the first reference value, the CPU controller 103 controls one core so as to operate within the range of limited clock frequencies, and so as to handle the delayed processing request.

Then, while the dual cores handle load, the CPU controller 103 identifies the number of work queues that the CPU must currently process, and compares the identified number of work queues with a second reference value. Herein, the second reference value is pre-designated, and represents the number of work queues that the dual cores operating within the range of limited clock frequencies are capable of processing while a user of the portable terminal cannot recognize a processing delay.

When a result of the comparison shows that the identified number of work queues exceeds the second reference value, the CPU controller 103 controls the quad cores so as to operate at a maximum clock frequency, and so as to quickly handle the delayed processing request. Otherwise, when the identified number of work queues is equal to or less than the second reference value, the CPU controller 103 compares the identified number of work queues with the first reference value, and determines, based on a result of the comparison, whether the CPU controller 103 operates one core at a limited clock frequency, or whether the CPU controller 103 operates dual cores at the limited clock frequency.

FIG. 2 is a block diagram illustrating the configuration of a CPU controller according to a first embodiment of the present invention

For illustrative purposes the first embodiment is an embodiment in which a CPU has dual cores.

Referring to FIG. 2, the CPU controller 103 includes a first core 201, a second core 203, a core determiner 205, and a load detector 207.

The first core 201 and the second core 203 are included in the CPU, and handle requested load (e.g. a thread). Then, the load detector 207 identifies the number of work queues that the entire CPU must process, and outputs the identified number of work queues to the core determiner 205.

Next, when power of the portable terminal is turned on, the core determiner 205 operates the first core 201 within a range of pre-designated limited clock frequencies. In the embodiment, a limited clock frequency is a clock frequency which is set within a range between a maximum clock frequency and a minimum clock frequency of the first core, and is set as a clock frequency or a higher one at which most applications or programs may be smoothly processed.

Then, the core determiner 205 receives the number of work queues, which the CPU must currently process, from the load detector 207. In the embodiment, multiple requests that the CPU must process are registered to a work queue, and the number of work queues may be represented on a thread-by-thread basis.

Next, the core determiner 205 compares the received number of work queues with a first reference value. Herein, the first reference value is pre-designated, and represents the number of work queues that the first core 201 operating within the range of limited clock frequencies is capable of processing while a user of the portable terminal cannot recognize a processing delay.

When a result of the comparison shows that the received number of work queues exceeds the first reference value, the core determiner 205 operates the first core 201 and the second core 203 at the maximum clock frequency. Otherwise, when the received number of work queues is equal to or less than the first reference value, the core determiner 205 operates the first core 201 within the range of limited clock frequencies without changing the clock frequency of the first core 201.

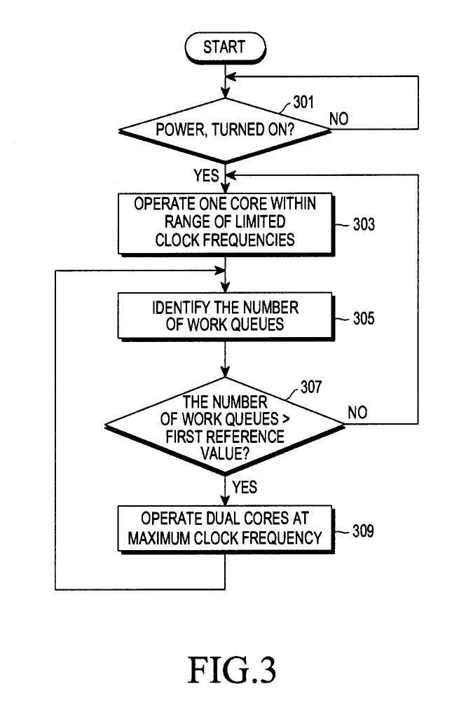

FIG. 3 is a flowchart illustrating a method for controlling a CPU by a CPU controller according to a first embodiment of the present invention.

Referring to FIG. 3, in step 301, the core determiner 205 identifies whether power of the portable terminal has been turned on.

When power of the portable terminal has been turned on, the core determiner 205 proceeds to step 303. Otherwise, the core determiner 205 repeatedly performs step 301. When proceeding to step 303, the core determiner 205 first operates the first core 201 within a range of pre-designated limited clock frequencies, and then proceeds to step 305.

In step 305, after receiving the number of work queues, which the CPU must currently process, from the load detector 207, the core determiner 205 proceeds to step 307. In step 307, the core determiner 205 compares the received number of work queues with a first reference value. When a result of the comparison shows that the identified number of work queues exceeds the first reference value, the core determiner 205 proceeds to step 309. Otherwise, the core determiner 205 returns to step 303.

When proceeding to step 309, the core determiner 205 first operates the first core 201 and the second core 203 at a maximum clock frequency, and then returns to step 305.

By returning to step 303 or step 305 as described above, according to the number of work queues, the core determiner 205 may operate only the first core 201 within the range of limited clock frequencies or may operate both the first core 201 and the second core 203 at the maximum clock frequency.

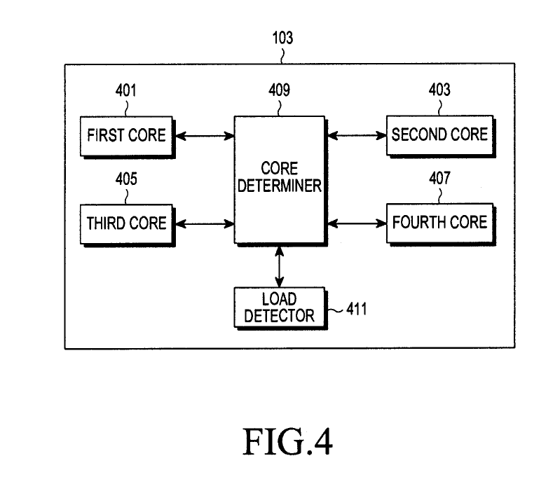

FIG. 4 a block diagram illustrating the configuration of a CPU controller according to a second embodiment of the present invention.

For illustrative purposes, the second embodiment is an embodiment in which a CPU has quad cores.

Referring to FIG. 4, the CPU controller 103 includes a first core 401, a second core 403, a third core 405, a fourth core 407, a core determiner 409, and a load detector 411.

The first core to the fourth core 401, 403, 405 and 407 are included in the CPU, and handle requested load (e.g. a thread). Then, the load detector 411 identifies the number of work queues that the entire CPU must process, and outputs the identified number of work queues to the core determiner 409.

Next, when power of the portable terminal is turned on, the core determiner 409 operates the first core 401 within a range of pre-designated limited clock frequencies. In the embodiment, a limited clock frequency is a clock frequency which is set within a range between a maximum clock frequency and a minimum clock frequency of the first core, and is set as a clock frequency or a higher one at which most applications or programs may be smoothly processed.

Then, the core determiner 409 receives the number of work queues, which the CPU must currently process, from the load detector 411. In the embodiment, multiple requests that the CPU must process are registered to a work queue, and the number of work queues may be represented on a thread-by-thread basis.

Next, the core determiner 409 compares the received number of work queues with a first reference value. Herein, the first reference value is pre-designated, and represents the number of work queues that one core operating within the range of limited clock frequencies is capable of processing while a user of the portable terminal cannot recognize a processing delay.

When a result of the comparison shows that the received number of work queues exceeds the first reference value, the core determiner 409 operates dual cores (e.g. the first core 401 and the second core 403) within a range between the minimum clock frequency and a limited clock frequency and. Otherwise, when the received number of work queues is equal to or less than the first reference value, the core determiner 409 operates the first core 401 within the range of limited clock frequencies without changing the clock frequency of the first core 401.

Then, while the dual cores handle load, the core determiner 409 receives the number of work queues, which the CPU must currently process, from the load detector 411, and compares the received number of work queues with a second reference value. Herein, the second reference value is pre-designated, and represents the number of work queues that the dual cores operating within the range of limited clock frequencies are capable of processing while a user of the portable terminal cannot recognize a processing delay.

When a result of the comparison shows that the received number of work queues exceeds the second reference value, the core determiner 409 operates the quad cores (e.g. the first core to the fourth core 401, 403, 405 and 407) at the maximum clock frequency. Otherwise, when the received number of work queues is equal to or less than the second reference value, the core determiner 409 compares the received number of work queues with the first reference value, and determines, based on a result of the comparison, whether the core determiner 409 operates the first core 401 at the limited clock frequency, or whether the core determiner 409 operates both the first core 401 and the second core 403 at the limited clock frequency.

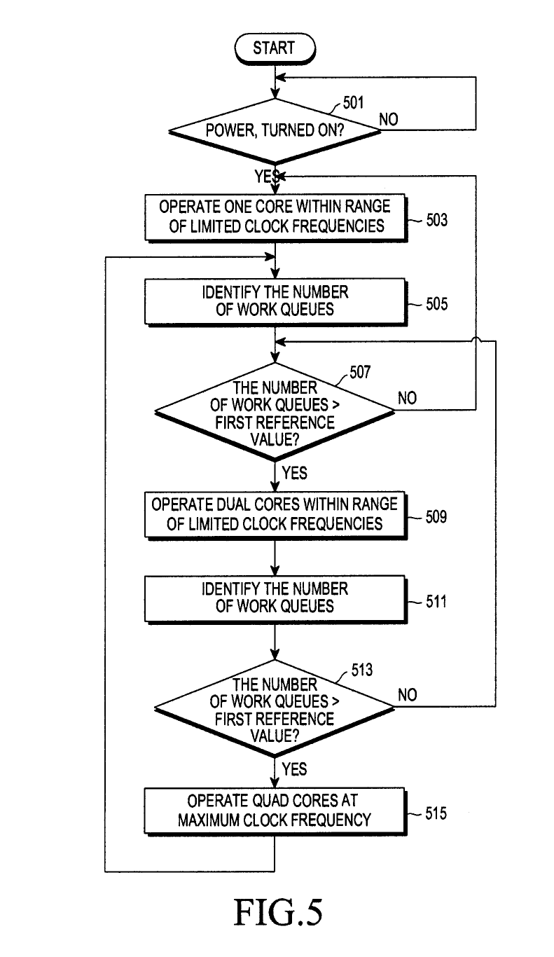

FIG. 5 is a flowchart illustrating a method for controlling a CPU by a CPU controller according to a second embodiment of the present invention.

Referring to FIG. 5, in step 501, the core determiner 409 identifies whether power of the portable terminal has been turned on. When power of the portable terminal has been turned on, the core determiner 409 proceeds to step 503. Otherwise, the core determiner 409 repeatedly performs step 501. When proceeding to step 503, the core determiner 409 first operates the first core 401 within a range of pre-designated limited clock frequencies, and then proceeds to step 505.

In step 505, after receiving the number of work queues, which the CPU must currently process, from the load detector 411, the core determiner 409 proceeds to step 507. In step 507, the core determiner 409 compares the received number of work queues with a first reference value. When a result of the comparison shows that the identified number of work queues exceeds the first reference value, the core determiner 409 proceeds to step 509. Otherwise, the core determiner 409 returns to step 503.

When proceeding to step 509, the core determiner 409 first operates dual cores (e.g. the first core 401 and the second core 403) at a limited clock frequency, and then proceeds to step 511. In step 511, after receiving the number of work queues, which the CPU must currently process, from the load detector 411, the core determiner 409 proceeds to step 513.

In step 513, the core determiner 409 compares the received number of work queues with a second reference value. When a result of the comparison shows that the received number of work queues exceeds the second reference value, the core determiner 409 proceeds to step 515. Otherwise, the core determiner 409 returns to step 507.

When proceeding to step 515, the core determiner 409 first operates the quad cores (e.g. the first core to the fourth core 401, 403, 405 and 407) at a maximum clock frequency, and then returns to step 505.

By returning to either step 503, step 505 or step 507 as described above, according to the number of work queues, the core determiner 409 may either operate only the first core 401 within the range of limited clock frequencies, may operate the first core 401 and the second core 403 within the range of limited clock frequencies, or may operate all of the first core to the fourth core 401, 403, 405 and 407 at the maximum clock frequency.

In the present invention as described above, the cores included in the CPU are operated within the range of limited clock frequencies, so as to optimize power consumption of the CPU.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the specific exemplary embodiments such as a portable terminal have been shown and described in the description of the present invention as described above, various changes in form and details may be made in the specific exemplary embodiments of the present invention without departing from the spirit and scope of the present invention. Therefore, the spirit and scope of the present invention is not limited to the described embodiments thereof, but is defined by the appended claims and equivalents.

For example, in the present invention, although the description has been made of a method for controlling a clock frequency of dual cores or quad cores. However, the teachings of the present invention is applicable to hexa cores or octa cores.

What is claimed is:

1. An apparatus for controlling a central processing unit (CPU) in a portable terminal, comprising:
a controller for operating a first core among multiple cores included in the central processing unit within a range of pre-designated limited clock frequencies, identifying a number of work queues corresponding to a number of processings being delayed by the CPU, comparing the identified number of work queues with a pre-designated reference value, and operating the first core and a second core among the multiple cores at a maximum clock frequency when a result of the comparison shows that the identified number of work queues exceeds the pre-designated reference value.

2. The apparatus as claimed in claim 1, wherein the controller operates the first core within the range of the limited clock frequencies when the identified number of work queues is equal to or less than the pre-designated reference value.

3. The apparatus as claimed in claim 1, wherein the limited clock frequency is determined in consideration of a correlation between the first core and a load that the first core handles for a pre-designated time period.

4. The apparatus as claimed in claim 1, wherein the pre-designated reference value corresponds to the number of work queues that the first core capable of operate within the range of the limited clock frequencies while a user of the portable terminal fails to recognize a processing delay.

5. An apparatus for controlling a central processing unit (CPU) in a portable terminal, comprising:
a plurality of cores;
a load detector for identifying a number of work queues that the CPU must process; and
a core determiner for comparing the identified number of work queues with a pre-designated reference value,
wherein a first core and a second core operate at a maximum clock frequency when the identified number of work queues exceeds the pre-designated reference value.

6. The apparatus as claimed in claim 5, wherein the first core operates within a range of limited clock frequencies without changing the clock frequency of the first core when the identified number of work queues is equal or less than the pre-designated reference value.

7. The apparatus as claimed in claim 5, wherein the first core and the second core operate within the range of limited clock frequencies without changing the clock frequency of the first core and the second core when the identified number of work queues is equal or less than the pre-designated reference value.

8. The apparatus as claimed in claim 5, wherein the first core, the second core, a third core, and a fourth core operate at a maximum clock frequency when the identified number of work queues exceeds the pre-designated reference value.

9. The apparatus as claimed in claim 5, wherein the limited clock frequency is determined in consideration of a correlation between the first core and a load that the first core handles for a pre-designated time period.

10. The apparatus as claimed in claim 5, wherein the pre-designated reference value corresponds to the number of work queues that the first core capable of operate within the range of the limited clock frequencies while a user of the portable terminal fails to recognize a processing delay.

11. A method for controlling a central processing unit (CPU) in a portable terminal, the method comprising:
operating at least one core among multiple cores included in the CPU within a range of pre-designated limited clock frequencies;
identifying a number of work queues corresponding to a number of processings being delayed by the CPU;
comparing the identified number of work queues with a pre-designated reference value; and
operating at least a first core and a second core among the multiple cores at a maximum clock frequency when a result of the comparison shows that the identified number of work queues exceeds the pre-designated reference value.

12. The method as claimed in claim 11, further comprising operating the at least first core within the range of the limited clock frequencies when the identified number of work queues is equal to or less than the pre-designated reference value.

13. The method as claimed in claim 11, wherein the limited clock frequency is determined in consideration of a correlation between the at least first core and a load that the at least first core handles for a pre-designated time period.

14. The method as claimed in claim 11, wherein the pre-designated reference value corresponds to the number of work queues that the at least first core capable of operating within the range of the limited clock frequencies while a user of the portable terminal fails to recognize a processing delay.
